(19) United States
(12) Patent Application Publication
(10) Pub. No.: US 2007/0287396 A1
(43) Pub. Date: Dec. 13, 2007

(54) Upgrading device and method using bootloader in wireless sensor networks

(75) Inventors: Tai-Yi Huang, Hsinchu (TW); Tsung-Yen Chen, Hsinchu (TW); Kai-Yuan Hou, Hsinchu (TW); Chung-Jung Lee, Hsinchu (TW)

Correspondence Address: BUCKNAM AND ARCHER, 1077 NORTHERN BOULEVARD, ROSLYN, NY, 11576, US

(73) Assignee: National Tsing Hua University, Hsinchu (TW)

(21) Appl. No.: 11/542,768

(22) Filed: Oct. 4, 2006

(30) Foreign Application Priority Data
Jun. 8, 2006 (TW) 095120296

(51) Int. Cl. H04B 1/18

(52) U.S. Cl. 455/185.1

(57) ABSTRACT

This invention provides an upgrading device using bootloader in wireless sensor networks which is installed at a wireless sensor. The wireless sensor is connected to a host terminal, which is characterized by comprising: a hardware initialization device for initializing the condition of the hardware while the sensor is on or reset; a wireless device driving device for providing wireless communication ability to the bootloader; and a difference algorithm decoding device, comprising at least one difference algorithm, for decoding and rebuilding the script file which is received.

### FIELD OF THE INVENTION

The present invention relates to an upgrading device and method using bootloader in wireless sensor networks.

### BACKGROUND OF THE INVENTION AND PRIOR ART

Wireless Sensor Networks (WSN) are a set of wireless sensor systems comprising a plurality of sensors, which have applications in, for example, detection of the intruder and the monitoring of the ecological environment.

However, the wireless sensor systems are usually suffering the problem of upgrading the software. Traditionally, the upgrading method is by means of manually connecting the sensor to a PC terminal via a physical transmission line (such as RS232 or USB, etc.) to perform a manual upgrading. Nonetheless, because of the increasing demanding on the usage requirement, the traditional way of upgrading is inadequate; once the sensors are deployed in the locations, such as volcanoes, skyscrapers, and oceans, etc., which are difficult to reach, then if the operating system or application software have to be upgraded due to a variety of reasons, such as program deficiency, functionality test, etc., the traditional way will be time consuming, wasting a lot of money, and may be very dangerous since it is necessary to retrieve the sensors and then manually connect the transmission lines to the sensors and upgrade the sensor one at a time.

For the past two years, some of the prior art begin to utilize the so-called network programming mechanism which use a wireless network to distribute the new software to the sensor end to complete the upgrade. However, because currently those techniques used in the prior art all implement the mechanism in the operating system layer or application software layer, the upgrading process may not be accomplished smoothly if the operating system is itself defective even though the wireless network can work properly.

The method of upgrading the system software via network programming appeared firstly in the literature [5], [6], which has a main drawback that no matter which part of the software, the system software or application programs, is going to be upgraded, the whole system must be upgraded accordingly, which may spend a lot of time and consume a lot of the power of the sensor. To resolve this shortcoming, the use of the difference algorithm to perform the upgrading were proposed in references [4] and [7], which is mainly based on transmitting the difference between the new and old versions in order to reduce the required energy during transmission; and furthermore the new version of the program can be recovered in the sensor.

However, all the references [4] to [7] share the same drawback that is, if there is a problem in the upgraded system software or the application program, it will result in the malfunction of the entire wireless sensor network. The wireless sensor which employs the upgrading method using bootloader to be described in the present invention is able to get rid of this problem since, when the system has the situation of abnormal operation, the regular program originally stored in the sensor will be adopted automatically in order to recover the normal system operation.

Additionally, on the one hand, in contrast to references [5], [6], the present invention further possesses the mechanism of difference algorithm in order to reduce the transmission burden. On the other hand, in contrast to references [4], [7], the present invention further provide the mechanism of dynamically replacing the difference algorithm so that the original upgraded system will have a higher degree of flexibility in order that the user can select an appropriate difference algorithm for the sensor or software to upgrade the system in accordance with the software and the hardware characteristics of the sensor needed to be upgraded.

### [Referred Patents]

[1] U.S. Application Publication No. 20060031426 “Programming a computing node connected to a sensor and an actuator”
[2] U.S. Application Publication No. 20050047670 “Data compression engines and real-time wideband compressor for multi-dimensional data”
[3] U.S. Application Publication No. 20050028001 “Secured software patching and upgrade method for densely deployed networks having spanning-tree topology”

### [Referred Literature]

[4] N. Reijers and K. Langendoen. Efficient code distribution in wireless sensor networks. In WSNA, pages 60-67, ACM Press 2003.
[5] Jaein Jeong, Sukun Kim and Alan Broad, “Network Programming,” TinyOS document.
[6] Crossbow Technology, “Mote in Network Programming User Reference.”
[7] J. Jeong and D. Culler, Incremental network programming for wireless sensors. In IEEE SECON, 2004.

### SUMMARY OF THE INVENTION

The present invention relates to a method that put the network upgrading mechanism into the bootloader because, when the system has a serious deficiency resulting in the crash of the system and therefore the upgrading cannot be proceeded, only the bootloading program that is burned in ROM or FLASH is the most reliable. Hence it can be used to upgrade the operating system or application software, etc.

Usually, while upgrading the system by using the network upgrading mechanism, the entire new version image would not be transmitted over the network because in WSN the act of transmission is the most power-consuming. Hence, in order to reduce the power consumption, an algorithm for calculating the difference between the new and old versions of the software is usually added in order to derive the difference between the new and old versions of the software in the server end, and then packet and encode before transmission. After the sensor end receives the encoded message, it will use the decoding program of the difference algorithm and the received message together with the old version software stored in the memory to recover the new version software. By doing so, the amount of data needed to be transmitted can be greatly reduced while only a little extra burden has to be paid in the generation of the new version software. In addition, the bootloader proposed in the present invention supports a replacement mechanism for the algorithm meaning that the user can also use the method of the network programming mechanism, in accordance with their own requirement, to replace the bootloader on the sensor end with their own required decoding program of the substituting algorithm.

In the mean time, the present invention also designs a set of difference algorithm. Currently, in most cases the amount of data needed to be transmitted for the proposed algorithm is relatively small in compared with the algorithm of the prior art. For the file with less difference between the new and old versions, over 90% of the amount of data transmission can be reduced.

Presently, in the literature the software upgrading is performed on the operating system or the application software layer, while the inventive technique is to upgrade the software and the firmware in the bootloader level, which is a highly reliable upgrading technique for, even if the operating system or the driver is out of order, the upgrading process can still be carried out; and furthermore the bootloader proposed in the present invention is able to support the replaceable difference algorithm.

For the difference algorithm, the proposed difference algorithm in the present invention is based on the string mapping and the greedy algorithm, which is an algorithm, while achieving a maximum amount of compression, that is able to precisely discover the difference between the new and old versions' binary files, in order to omit the unnecessary upgrading, and then encodes the result so as to save a maximal transmission energy consumption.

In order to achieve the above-mentioned objective, the present invention provides an upgrading device using bootloader in wireless sensor networks which is installed at a wireless sensor. The wireless sensor is connected to a host terminal, which is characterized by comprising: a hardware initialization device for initializing the condition of the hardware while the sensor is on or reset; a wireless device driving device for providing wireless communication ability to the bootloader; and a difference algorithm decoding device, comprising at least one difference algorithm, for decoding and rebuilding the script file which is received.

### BRIEF DESCRIPTION OF THE DRAWINGS

Preferred embodiments of the present invention are subsequently described by referring to the enclosing drawings, wherein:

FIG. 1 shows a configuration diagram of the bootloader.

FIG. 2 shows a flowchart for the network upgrading programming mechanism.

FIG. 3 shows a representation diagram of the BFC difference algorithm.

FIG. 4 shows a comparison diagram for various types of difference algorithms.

### DETAILED DESCRIPTION OF THE PREFERRED EMBODIMENTS

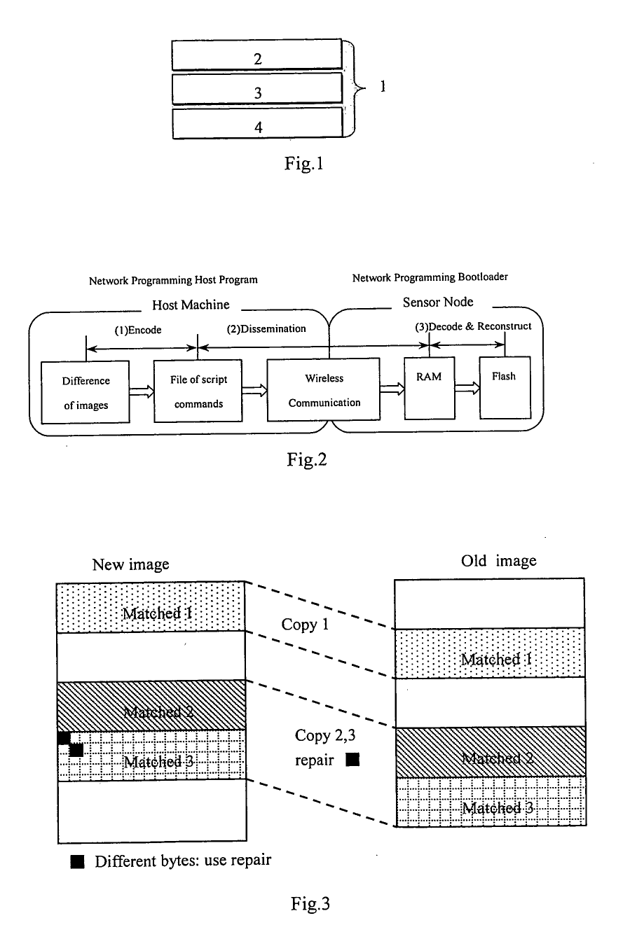

First of all, FIG. 1 shows a configuration diagram of the bootloader, which comprises of three layers: hardware initialization, driver for wireless devices, and decoding program of the difference algorithm.

In the bottom layer, the hardware initialization is used to, when the sensor is starting or resetting, initialize the status of the hardware such as SDRAM, clock, power management unit, etc. Because the wireless communication may be proceeded via UART, interfaces, such as USB or UART, etc., must also be initialized in order to equip with wireless communication capability.

The second layer is the driver for wireless devices, which will allow the bootloader to have the wireless communication capability. Since the bootloader is necessary to have the ability of transmitting or receiving packets, the second layer will be provided with a communication protocol.

The top layer of the bootloader is the decoding program of the difference algorithm, which is capable of decoding and reconstructing the script file coming from the server of the host end. In the host end, the server will compare the difference between the new and old image files and then encode the result into a script file, which will then be transmitted to each sensor end by means of the electromagnetic wave. When the sensor end receives the script file, it will employ the decoding program of the difference algorithm to recover the new image file and then store it in the flash memory. In the present invention, the bootloader can be used to download or execute different algorithm, and therefore provide the user with a variety of selections, accordingly.

FIG. 2 shows a flowchart for the network upgrading programming mechanism. Firstly, beginning with the host end, the flowchart starts with the first stage, namely the encoding stage, which at first compares the difference between the new and old versions' image files, and then generates a script file for the upgrading instruction. Then in the second stage, the transmission stage, the script file is sent from the host end to the sensor end via the wireless communication means. Next, in the third stage, decoding and recovering, when the sensor end receives the script file, the image file will be recovered in the memory by utilizing the decoding program of the difference algorithm, and then store it in the flash memory.

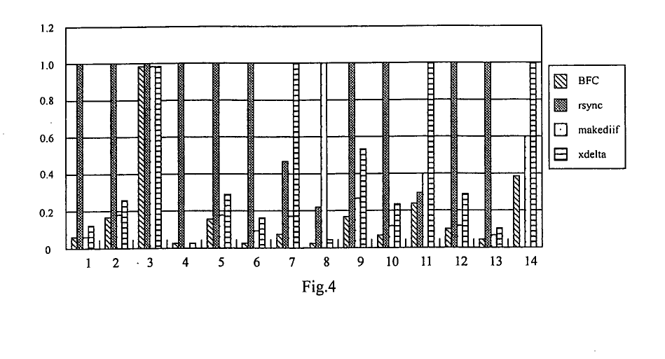

In the following, reference is made to FIG. 3 in order to describe the BFC (Binary File Comparison) difference algorithm.

If a new image file is about to be generated, the new and old versions' image files are compared firstly to precisely find out the difference between these two files. As shown in FIG. 3, because the identical block 1 of the old image file only changes its position in the new image file while the content does not change, therefore a “copy 1” instruction can be issued in the script file indicating that the identical block 1 in the old image file can be directly copied to the new image file. Similarly, it is only necessary to execute a “copy 2” instruction for the identical block 2 of the old image file. However, the situation for the identical block 3 is a little bit different. Because generally it is still the same with only a small part of the block is different, and it is adjacent to the identical block 2, therefore the “copy 2, 3” instruction can be executed first to copy the identical blocks 2 and 3 together to the new image file, while a “repair” instruction must be attached in order to subsequently modify the point of difference between the new and old versions (the black block shown in the figure). Finally, write the part that does not exist in the old image file into the new image file by using an “insert” instruction (not shown in the figure).

FIG. 4 shows a comparison diagram of different sizes of files generated by different algorithm. After comparing the result by using the above mentioned method, the present invention, except the part that is necessary to be upgraded, all other contents in the old image files that do not change or only have a minor modification can be easily accomplished by a set of simple instructions, which can further reduce the size of the to-be-transmitted script file to a minimum; and therefore the objective of fast transmission and reduction of the energy consumption can be achieved.

According to FIG. 4, the difference algorithm proposed in the present invention has the best compression efficiency. In [1] the makediff algorithm is used whereas the Rsync algorithm is adopted in [2]. Our BFC algorithm in the comparison of each data item has the highest compression rate in every respect and is therefore able to greatly reduce the time and energy consumption during the upgrading process.

Although the present invention is disclosed in the preferred embodiments described above, the inventive idea should not be limited only to those. The present invention can also be applied to digital television satellite broadcast, high-speed Ethernet network, high-speed wireless local area network, and wireless metropolitan network, etc. It will be understood by those skilled in the art that various other changes in the form and details may be made without departing from the spirit and scope of the present invention. It is to be understood that various changes may be made in adapting to different embodiments without departing from the broader concepts disclosed herein and comprehended by the claims that follow.

### LIST OF REFERENCE NUMERALS

### 1 Bootloader

### 2 Decoding program of the difference algorithm

### 3 Driver for wireless devices

4 Hardware initialization

1. An upgrading device for a wireless sensor using bootloader which is installed at a wireless sensor, said wireless sensor being connected to a host terminal, wherein it in that said device comprises:
a hardware initialization device for initializing the condition of the hardware while the sensor is on or reset;
a wireless device driving device for providing wireless communication ability to the bootloader; and
a difference algorithm decoding device, comprising at least one difference algorithm, for decoding and rebuilding the script file which is received.

2. An upgrading device in accordance with claim 1, wherein the difference algorithm is based on the principles of string mapping and greedy algorithm.

3. An upgrading method for a wireless sensor using bootloader which is executed at a wireless sensor, said wireless sensor being connected to a host terminal, characterized in that the method comprises:
a hardware initialization step for initializing the condition of the hardware while the sensor is on or reset;
a wireless device driving step for providing wireless communication ability to the bootloader; and
a difference algorithm decoding step, comprising at least one difference algorithm, for decoding and rebuilding the script file which is received.

4. An upgrading method in accordance with claim 3, wherein the difference algorithm is based on the principles of string mapping and greedy algorithm.

5. A recording medium that stores the difference calculation program, wherein the difference calculation program comprises the following steps:
a comparing step for comparing the difference between the original script file and the to-be-generated script files, and then generating a comparing result;
a copy step for copying the entire part, in which the content has not been modified, from the original script file to the to-be-generated script file in accordance with the comparing result;
a repair step for copying the entire part, in which the content has been modified, from the original script file to the to-be-generated script file and then performing correction; and
an insert step for add the part that does not exist in the original script file to the to-be-generated script file.

6. A recording medium in accordance with claim 5, wherein the difference calculation program is based on the principles of string mapping and greedy algorithm.
